(19) United States
(12) Patent Application Publication
(10) Pub. No.: US 2021/0141869 A1
(43) Pub. Date: May 13, 2021

(54) Automated Analysis of Mechanical Designs

(71) Applicant: Disney Enterprises, Inc., Burbank, CA (US)

(72) Inventors: Moritz Niklaus Bächer, Zurich (CH); Christian Hafner, Vienna (AT); Bernd Bickel, Klosterneuburg (AT); Christian Gabriel Schumacher, Zurich (CH); Lars Espen Knoop, Zurich (CH)

(21) Appl. No.: 16/678,898

(22) Filed: Nov. 8, 2019

(51) Int. Cl. G06F 17/50

(52) U.S. Cl. CPC G06F 17/5086; G06F 2217/16; G06F 2217/06; G06F 17/5009

(57) ABSTRACT

An automated mechanical design analysis system includes a computing platform having a hardware processor and a system memory storing a software code. The hardware processor executes the software code to receive an input model of a mechanical object, identify one or more design parameter(s) of the input model for automated analysis, and perform a parametric mapping of the input model based on the design parameter(s) to produce a parameterized model corresponding to the input model. The hardware processor further executes the software code to embed the parameterized model in a grid to produce model-grid intersections defining multiple subvolumes of the parameterized model, and generate a simulation of the input model based on the model-grid intersections and the subvolumes, where the simulation of the input model provides a differentiable mathematical representation of the input model.

### BACKGROUND

In modern Computer-Aided Design (CAD) systems, a boundary representation composed primarily of Non-Uniform Rational Basis Spline (NURBS) patches is typically used to describe solid models. The efficacy of such boundary representations is attributed to the many desirable properties of NURBS, which enable the precise representation of analytical and free-form shapes, their intuitive control, and modeling operations such as extrusion, chamfering, or blending. Nevertheless, and despite the advantages of boundary representations for manual design, strength-to-weight or rest shape optimization require the solution of a Partial Differential Equation (PDE) on the volume enclosed by the representative boundary.

Although progress has been made in isogeometric analysis, where PDEs are solved on volumetric NURBS representations, the generation of volumetric NURBS for general boundary representation input continues to present challenges in the conventional art. As a result, it is still typical to solve PDEs on a volumetric mesh representation. However, because shape optimization requires a differentiable simulator, and even moderate changes to design variables demand repeated conversion and remeshing, the use of CAD in combination with design optimization remains unfortunately limited in the conventional art.

### SUMMARY

There are provided systems and methods for performing automated analysis and/or optimization of mechanical designs, substantially as shown in and/or described in connection with at least one of the figures, and as set forth more completely in the claims.

### BRIEF DESCRIPTION OF THE DRAWINGS

FIG. 1 shows a diagram of an exemplary system for performing automated analysis of mechanical designs, according to one implementation;

FIG. 2 shows an exemplary process flow for performing automated analysis of mechanical designs, according to one implementation;

FIG. 3 shows a flowchart presenting an exemplary method for performing automated analysis and/or optimization of mechanical designs, according to one implementation;

FIG. 4 shows an exemplary design analysis software code suitable for use by the system shown in FIG. 1, according to one implementation;

FIG. 5A shows an exemplary constraint graph used to parameterize an input model, according to one implementation;

FIG. 5B depicts details of a subvolume used in a simulation stage of the process flow shown in FIG. 2, according to one implementation; and

FIG. 6 shows several examples of curve integral parameterizations performed as part of an automated analysis of mechanical designs, according to one implementation.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

The present application discloses systems and methods for performing automated analysis of mechanical designs that overcome the drawbacks and deficiencies in the conventional art. It is noted that, as used in the present application, the terms “automation,” “automated”, and “automating” refer to systems and processes that do not require the participation of a human user, such as a human designer or engineer. Although, in some implementations, a human designer or engineer may review the simulated or substantially optimized mechanical models generated by the automated systems and according to the automated methods described herein, that human involvement is optional. Thus, the methods described in the present application may be performed under the control of hardware processing components of the disclosed automated systems.

FIG. 1 shows a diagram of an exemplary system for performing automated analysis of mechanical designs, according to one implementation. As shown in FIG. 1, system 100 includes computing platform 102 having hardware processor 104, and system memory 106 implemented as a non-transitory storage device. According to the present exemplary implementation, system memory 106 stores design analysis software code 110. In addition, in some implementations, system 100 may include display 108, which may be integrated with computing platform 102, or may be a discrete display communicatively coupled to computing platform 102.

As further shown in FIG. 1, system 100 is implemented within a use environment including communication network 120, user device 130 including display 138, and user 132 utilizing user device 130. Also shown in FIG. 1 are network communication links 122 interactively connecting user device 130 and system 100 via communication network 120, input model 140, and optimized model 160 corresponding to input model 140 and produced using design analysis software code 110.

It is noted that, in various implementations, optimized model 160, when produced using design analysis software code 110, may be stored in system memory 106 and/or may be copied to non-volatile storage (not shown in FIG. 1). Alternatively, or in addition, as shown in FIG. 1, in some implementations, optimized model 160 may be sent to user device 130 including display 138, for example by being transferred via network communication links 122 of communication network 120.

Although user device 130 is shown as a desktop computer in FIG. 1, that representation is merely exemplary. More generally, user device 130 may be any suitable mobile or stationary computing device or system that implements data processing capabilities sufficient to provide a user interface, support connections to communication network 120, and implement the functionality ascribed to user device 130 herein. For example, in other implementations, user device 130 may take the form of a laptop computer, tablet computer, or smartphone, for example. Moreover, in some implementations, user device 130 may take the form of a wearable personal communication device, such as an augmented reality (AR) or virtual reality (VR) headset or glasses, a smartwatch, or another smart personal item worn by user 132 and including display 138. It is noted that display 138, as well as display 108 of system 100, may take the form of a liquid crystal display (LCD), a light-emitting diode (LED) display, an organic light-emitting diode (OLED) display, or any other suitable display screen that performs a physical transformation of signals to light.

It is also noted that although the present application refers to design analysis software code 110 as being stored in system memory 106 for conceptual clarity, more generally, system memory 106 may take the form of any computer-readable non-transitory storage medium. The expression “computer-readable non-transitory storage medium,” as used in the present application, refers to any medium, excluding a carrier wave or other transitory signal that provides instructions to hardware processor 104 of computing platform 102. Thus, a computer-readable non-transitory medium may correspond to various types of media, such as volatile media and non-volatile media, for example. Volatile media may include dynamic memory, such as dynamic random access memory (dynamic RAM), while non-volatile memory may include optical, magnetic, or electrostatic storage devices. Common forms of computer-readable non-transitory media include, for example, optical discs, RAM, programmable read-only memory (PROM), erasable PROM (EPROM), and FLASH memory.

Moreover, although FIG. 1 depicts design analysis software code 110 as being stored as a single set of software instructions, that representation is also merely exemplary. More generally, system 100 may include one or more computing platforms, such as computer servers for example, which may form an interactively linked but distributed system, such as a cloud-based system, for instance. As a result, hardware processor 104 and system memory 106 may correspond to distributed processor and memory resources within system 100. Thus, the various software modules included in design analysis software code and described below by reference to FIG. 4 may be stored remotely from one another and may be executed by the distributed processor resources of system 100.

In one implementation, for example, computing platform 102 of system 100 may correspond to one or more web servers, accessible over a packet-switched network such as the Internet, for example. Alternatively, computing platform 102 may correspond to one or more computer servers supporting a wide area network (WAN), a local area network (LAN), or included in another type of limited distribution or private network.

FIG. 2 shows exemplary process flow 200 for performing automated analysis of mechanical designs, according to one implementation. An overview of the automated design analysis solution implemented using exemplary system 100 will be described by reference to process flow 200. As shown in FIG. 2, process flow 200 includes receiving input model 240 of mechanical object 242 and implementing a process including parameterization stage 252, grid embedding stage 254, simulation stage 256, and optimization stage 258. As further shown in FIG. 2, process flow 200 provides optimized model 260 corresponding to input model 240 as an output. It is noted that input model 240 and optimized model 260 correspond respectively in general to input model 140 and optimized model 160, in FIG. 1. As a result, input model 240 and optimized model 260 may share any of the characteristics attributed to respective input model 140 and optimized model 160 by the present disclosure, and vice versa.

It is further noted that although the following discussion refers to input model 140/240 and optimized model 160/260 as Computer-Aided Design (CAD) models in the interests of conceptual clarity, that characterization is merely exemplary. More generally, input model 140/240 and optimized model 160/260 may be any boundary representation suitable for modeling mechanical objects.

Referring to parameterization stage 252 of process flow 200, a general form of a CAD model may be described as a closed Non-Uniform Rational Basis Spline (NURBS) object, i.e., a set of NURBS patches that form a C⁰ surface. It is assumed that user 132 supplying input model 140 applied appropriate engineering judgment during initial design. Projective coordinates may be used to represent NURBS patches where points [wx, wy, wz]^{T} in Euclidean coordinates are represented with points [x,y,z]^{T} in projective space [symbol] ³. As a result, a NURBS patch with control points q_{i,j} ∈ [symbol] ³ and polynomial basis functions B_{i,j}: [symbol] ²→ [symbol] may be considered to be a parametric mapping:

σ: [symbol] ²→ [symbol] ³u [symbol] Σ_{i,j}B_{i,j}(u)q_{i,j} (Equation 1)

from uv-coordinates u=[u, v]^{T} to a point σ(u) in projective coordinates. In contrast to the rational form \hat{σ}: [symbol] ²→ [symbol] ³ in Euclidean space, this form is more convenient for simulation and optimization because σ is polynomial. This definition is used consistently, and Euclidean coordinates may be recovered by perspective division where necessary.

During optimizations, the present approach seeks to ensure that a model remains manufacturable, and changes to shape parameters do not negatively impact its function or characteristic appearance. For instance, in CAD, it is commonplace to round off sharp edges and corners of models by introducing fillets. If control points of patches are moved in an uncontrolled manner, sharp features between neighboring patches could be inadvertently reintroduced.

To prevent undesirable changes to the model, user 132 may be permitted to define, a priori, an implicit mapping from high-level shape parameters p to the set of m control points q∈ [symbol] ^{4m} of the NURBS boundary:

cₚₐᵣₐ(p,q(P))=0 (Equation 2)

During optimizations, these constraints cₚₐᵣₐ are enforced, keeping the number and topology of patches fixed.

Referring to grid embedding stage 254 of process flow 200, it is noted as a preliminary matter that the process being described is directed to shape optimization of CAD representations where objectives depend on the elastic response of the material delimited by the boundary representation. To achieve this goal, the simulation generated in subsequent simulation stage 256 must be sufficiently smooth and differentiable. A standard conformal Finite Element Method (FEM) discretization is poorly suited for the task at hand because, if the shape of a model undergoes significant changes, remeshing is unavoidable. These uncontrolled topological changes lead to a discontinuity, and therefore to a non-differentiable simulation.

To mitigate this problem, the present solution includes grid embedding stage 254 prior to simulation, in which the CAD model is embedded in a simulation grid, such as a three-dimensional (3D) regular hexahedral grid for example. The geometry of this simulation grid remains constant. That is to say, the geometry of the grid in which the parameterized model is embedded does not change during simulation or during optimization.

Referring to simulation stage 256 of process flow 200, in order to determine the elastic response x∈ [symbol] ³ⁿ of a CAD model, the present approach seeks to minimize the standard potential energy:

E(x)=Eᵢₙₜ(x)−Eₑₓₜ(x) with Eᵢₙₜ(x)=∫_{V}Ψ(x,X)dV (Equation 3)

where the material-dependent strain energy density, Ψ, is integrated over points x∈ [symbol] ³ in the undeformed volume V. The result of this minimization is a static equilibrium

$$\frac{\partial E}{\partial x} = 0$$

where the internal or elastic forces E_{int,x} are in balance with external forces E_{ext,x}. However, in contrast to standard FEM, the volume V enclosed in the CAD model is the intersection of the boundary representation of the model with the grid into which the model was embedded in grid embedding stage 254, and elements on the boundary are cut into arbitrarily complex subvolumes.

To represent the solid-void boundary in cut elements of mechanical object 242 being modeled, implicit descriptions where assigned distances to the boundary are discretized at grid nodes, are common. However, those features fail to resolve the sub-element detail.

In order to loosen the coupling between grid resolution and simulation precision, the present approach represents cuts in elements explicitly with an enrichment and implements a quadrature scheme that integrates quantities such as the elastic energy Eᵢₙₜ over complex subvolumes reliably and accurately.

To those ends, the present application discloses novel and inventive advances over conventional techniques that include:
1) a modified set of quadrature rules that accurately handle integration over curved domains of varying shape and size, defined by NURBS and planar patches;
(2) a refinement of rule construction to significantly reduce the cost of evaluations of shape derivatives and updates to rules when shape parameters change; and
(3) a change of basis for enriched shape functions that makes it straightforward to turn standard FEM into efficient eXtended Finite Element Method (XFEM) implementations.

The simulation technique implemented in simulation stage 256 of process flow 200 and outlined above is described in greater detail below with reference to FIGS. 3, 4, 5A, and 5B.

Referring to optimization stage 258 of process flow 200, it is noted that a first generic type of objective that the present approach seeks to optimize integrates a function g that depends on the elastic response of the model over the volume enclosed by the boundary representation:

f(q(p),x(p))=∫_{V(q)}g(x,X)dV (Equation 4)

Because the control points of the boundary representation define the volume V, and changes to shape parameters translate to changes in control points, the rest shape of the model, and consequently also its elastic response, implicitly depend on the shape parameters p.

In some implementations, it may be advantageous or desirable to minimize objectives that depend on the elastic response together with mass distribution objectives. For example, to optimize the strength-to-weight ratio of an asymmetric wheel design, the center of mass must lie on the axis of the wheel, and the major axis of the moment of inertia must align with this axis.

To support the co-optimization of such combined objectives, the present solution introduces a second type of objective that integrates standard functions over the volume defined by the boundary representation:

f(q(p))=∫_{V(q)}g(X)dV (Equation 5)

Substituting either a constant or spatially-varying density ρ(X) times a monomial t∈{1, X, Y, Z, XY, XZ, YZ, X², Y², Z²} for the integrand, the mass, center of mass, and moment of inertia of a model can be determined. For example, integration of the density ρ(X) (times the constant 1) yields the mass of a CAD model, and can be combined with the objective described by Equation 4 above to formulate strength-to-weight ratio optimizations.

A third type of objective that may be utilized in the automated design analysis solution disclosed in the present application depends solely on the elastic response of a model:

f(x(p))=g(x) (Equation 6)

This type of objective enables, for example, inverse shape design, where the rest shape of the model is optimized such that the deformed model matches a target shape under a predefined load as closely as possible.

The optimization performed during optimization stage 258 of process flow 200 seeks to minimize one of the objectives described by Equations 4, 5, or 6, or a weighted combination of those objectives over the parameterized volume enclosed by the CAD model:

$$\begin{matrix}min \\ p\end{matrix} f ( p , q ( p ) , x ( p ) ) s . t . \begin{matrix}{c}_{para} ( p , q ( p ) ) = 0 \\ {E}_{x} ( q ( p ) , x ( p ) ) = 0\end{matrix} \qquad ( Equation 7 )$$

enforcing first-optimality constraints on the parameterization and the elastic response. To prevent shape parameters from taking on values that would lead to non-manufacturable designs, an additional term is added to f that directly depends on p (e.g., to penalize the radii of two cylinders to prevent them from overlapping), hence the direct dependence of f on p.

Thus, to enable shape optimization on CAD, the present novel and inventive solution introduces:
(1) a continuous projection of shape parameters onto the constraint manifold spanned by the user-specified parameterization, guaranteeing that the problem is well posed, and
(2) a technique to efficiently compute derivatives of our hierarchical quadrature rules.

The optimization technique implemented in optimization stage 258 of process flow 200 and outlined above is described in greater detail below with reference to FIGS. 3, 4, and 6. It is noted that a significant benefit of the design analysis solution disclosed in the present application is that structural or related objectives are directly minimized on a CAD representation, and the optimized output, i.e., optimized model 160/260, can be loaded into a modeling tool for further refinement, or may be used to design a mold for manufacturing mechanical object 242 it models.

The functionality of system 100 including design analysis software code 110 will be further described by reference to FIG. 3 in combination with FIGS. 1, 2, and 4. FIG. 3 shows flowchart 370 presenting an exemplary method for use by a system, such as system 100, in FIG. 1, to perform automated analysis of mechanical designs. With respect to the method outlined in FIG. 3, it is noted that certain details and features have been left out of flowchart 370 in order not to obscure the discussion of the inventive features in the present application.

FIG. 4 shows exemplary design analysis software code 410 suitable for execution by hardware processor 104 of the system 100, according to one implementation. As shown in FIG. 4, design analysis software code 410 may include parametric mapping module 412, grid embedding module 414, simulation module 416, and optimization module 418. Also shown in FIG. 4 are input model 440, parameterized model 444 corresponding to input model 440, and optimized model 460.

Input model 440 and optimized model 460 correspond respectively in general to input model 140/240 and optimized model 160/260, in FIGS. 1 and 2, and may share any of the characteristics attributed to those corresponding features by the present disclosure. In other words, like input model 140/240 and optimized model 160/260, input model 440 and optimized model 460 may be a CAD model.

Moreover, design analysis software code 410 corresponds in general to design analysis software code 110, in FIG. 1, and those corresponding features may share any of the characteristics attributed to either of design analysis software code 110 or design analysis software code 410 by the present disclosure. That is to say, like design analysis software code 410, design analysis software code 110 may include modules corresponding respectively to parametric mapping module 412, grid embedding module 414, simulation module 416, and optimization module 418.

Referring now to FIG. 3 in combination with FIGS. 1, 2, and 4, flowchart 370 begins with receiving input model 140/240/440 of mechanical object 242 (action 371). By way of example, user 132 may utilize user device 130 to interact with system 100 to generate optimized model 160/260/460 corresponding to input model 140/240/440. As shown by FIG. 1, in one implementation, user 132 may do so by transmitting input model 140/240/440 from user device 130 to system 100 via communication network 120 and network communication links 122. Alternatively, input model 140/240/440 may be received from a third party source, or may be stored in and retrieved from system memory 106.

As noted above, input model 140/240/440 may take the form of any suitable boundary representation of mechanical object 242. For example, and as further noted above, input model 140/240/440 may be a CAD model of mechanical object 242. Moreover, input model 140/240/440 may include multiple NURBS patches forming a C⁰ surface. Input model 140/240/440 may be received by design analysis software code 110/410, executed by hardware processor 104.

Flowchart 370 continues with identifying one or more design parameters (hereinafter “design parameter(s)”) of input model 140/240/440 for automated analysis (action 372). Design parameter(s) for input model 140/240/440 may be provided as inputs to user device 130 by user 132 and may be received by system 100 via communication network 120 and network communication links 122. Alternatively, or in addition, in some implementations, design parameter(s) for input model 140/240/440 may accompany input model 140/240/440, such as in the form of metadata, for example. In some implementations, identification of design parameter(s) for input model 140/240/440 may be performed through a preliminary automated analysis of input model 140/240/440 performed by system 100. Action 372 may be performed by design analysis software code 110/410, executed by hardware processor 104.

Flowchart 370 continues with performing a parametric mapping of input model 140/240/440 based on the design parameter(s) identified in action 372 to produce parametrized model 444 corresponding to input model 140/240/440 (action 373). It is noted that the parameterization technique performed in action 373 is discussed in detail below by reference to a specific implementation in which input model 140/240/440 is a CAD model, in the interests of conceptual clarity. However, that specific implementation is provided merely by way of example. The parametric mapping of input model 140/240/440 in action 373 and described below may be performed by design analysis software code 110/410, executed by hardware processor 104, and using parametric mapping module 412.

Adjacent patches in CAD models often meet tangentially along edges, for example when fillets are used to remove sharp features. It is generally desirable to preserve these tangencies. Hardware processor 104 may execute design analysis software code 110/410 to utilize parametric mapping module 412 to detect those relationships and to ensure that they are maintained during subsequent simulation and optimization stages 256 and 258.

When a CAD file is imported, a constraint graph may be generated in which vertices correspond to patches, and in which two vertices are connected by an edge if the patches are adjacent and tangential. FIG. 5A shows exemplary constraint graph 546 used to parameterize input model 140/240/440, according to one implementation. In the example shown in FIG. 5A, a plane P₁, two cylindrical sections C₁ and C₂, and another plane P₂ are connected in the graph. For every edge, the surface relationship is determined from the relevant parameters, and the constraints are quantified as a list of equalities: e₁, e₂, e₃ in FIG. 5A.

The present design analysis solution enables user 132 to utilize user device 130 to define a shape parameter on the surface of input model 140/240/440, e.g., the radius r₂ of cylinder C₂. A list of patches that are connected to the selected parameter via the constraint graph may then be presented to user 132. User 132 may have the option of making additional modifications to the parameter definition, e.g., to keep certain patches fixed, or to enforce symmetries in the model. All remaining patches may be marked as free.

The constraints Cₚₐᵣₐ defined by Equation 2 above, together with the user specified parameters determine an implicit mapping from high-level shape parameters p to low-level control points q. However, during subsequent optimizations, the set of parameters can take on values for which no corresponding set of control points exists such that the constraints are satisfied. Conversely, the set of constraints may not fully constrain the control points, meaning that a subset of them could move freely without violating the constraints.

To ensure that the optimization problem will be well-posed, independent of the parameterizations specified by user 132, shape parameters, p_{⊥}, are introduced that represent the projection of a given set of values p onto the constraint manifold, or the closest set of valid shape parameters. For control points that are insufficiently constrained, it is most natural to ask for values that remain closest to their original values \hat{q}, amounting to the least changes in shape compared to the input. The objective:

fₚₐᵣₐ(p_{⊥},q)=½∥p_{⊥}−p∥²+½∥q(p_{⊥})−\hat{q}∥² (Equation 8)

is minimized over the constraint manifold spanned by cₚₐᵣₐ, or the corresponding Lagrangian:

[symbol]

(p_{⊥},q,λ)=fₚₐᵣₐ(p_{⊥},q)−λ^{T}cₚₐᵣₐ(p_{⊥},q(p_{⊥})) (Equation 9)

to first-order optimality. It is noted that the first two terms in the parameterization objective fₚₐᵣₐ defined by Equation 8 do not interfere with one another because the control points are only instantiated for a set of valid shape parameters that lie on the constraint manifold.

Flowchart 370 continues with embedding parameterized model 444 in a grid to produce multiple model-grid intersections defining subvolumes of parameterized model 444 (action 374). The purpose of action 374 is discussed above by reference to grid embedding stage 254 of process flow 200. FIG. 5B depicts an exemplary subvolume 548 of parameterized model 444, according to one implementation, which is discussed in greater detail below by reference to action 375.

It is noted that the grid utilized in action 374 may be a regular grid, such as a regular hexahedral grid, for example. Moreover, the grid used in action 374 may have a 3D geometry that remains constant during subsequent simulation and optimization. The embedding of parameterized model 444 into a grid in action 374 may be performed by design analysis software code 110/410, executed by hardware processor 104, and using grid embedding module 414.

Flowchart 370 continues with generating a simulation of input model 140/240/440 based on the model-grid intersections produced and the subvolumes defined as a result of the grid embedding described above, where the simulation of input model 140/240/440 provides a differentiable mathematical representation of input model 140/240/440 (action 375). It is noted that in the continued interests of conceptual clarity, the simulation performed in action 375 is discussed by reference to a specific and merely exemplary implementation in which input model 140/240/440 is a CAD model. Generation of the simulation of input model 140/240/440 in action 375 may be performed by design analysis software code 110/410, executed by hardware processor 104, and using simulation module 416.

To simulate a complex CAD model on a simulation grid that is not conformal, quadrature rules are required for integration of functions over (1) subvolumes, which are part of the model interior (e.g., to accumulate elastic force density), and over (2) regions on the model surface (e.g., to aggregate surface traction). In the present setting, quadrature rules are not readily available because the integration domains are generated at runtime as intersections between arbitrary models and grid planes. In the following, we assume that the NURBS patches were cut along edges and faces of a regular hexahedral grid used in action 374.

The expression g: [symbol] ²→ [symbol] (denotes a general function that is defined on the volumetric domain enclosed by the CAD model. The present goal is to construct quadrature rules that exactly integrate g drawn from a function space spanned by a set of basis functions, over a domain D:

∫_{D}g(X)dD=Σⱼwⱼg(Xⱼ) (Equation 10)

Referring to FIG. 5B, the domain D may be one-dimensional for integration along axis-aligned edges E or curves C, two-dimensional for integration over planar patches A or curved surfaces S, or 3D for integrals over volumetric domains V. It is noted that because integration is performed over undeformed domains, the expression Xⱼ∈ [symbol] ³ may be used to refer to quadrature points corresponding to weights wⱼ.

To integrate along axis-aligned edge segments E in FIG. 5B we form one-dimensional integrals, for example ∫_{[a,b]}g(X, Y, Z) dX for an integral along the X-axis. A change of variables is performed to map the interval [a,b], delimited by the two segment endpoints, to the interval [0, 1], then a standard Gauss-Legendre rule may be applied.

Intersections of NURBS patches with hexahedral elements form planar curves that are embedded in planes parallel to one of the coordinate planes. For accurate integration along curves C in FIG. 5B the curves are parameterized with a mapping from t∈[a, b] to spatial curve points r(t), and then a Gauss-Legendre rule may be used for numerical integration of the transformed integrals ∫_{[a,b]}g(r(t))∥r′(t)∥dt where r′ denotes the derivative of the mapping with respect to parameter t.

While we can expect intersection curves to be sufficiently smooth, we cannot, in general, extract analytical parameterizations from intersections of the boundary representation with the hexahedral grid. Consequently, the intersections are represented with sample points, and the parametric form of the boundary representation can be approximated with a Lagrange interpolating polynomial. It is noted that, as known in the art, the accuracy of the Gauss-Legendre integration is preserved for a polynomial interpolation of sufficiently high degree.

To integrate over planar areas and surfaces, a first nesting of the hierarchical integration scheme described in the present application is employed. There are two cases to consider: (1) integrals over planar areas that lie in grid planes of the simulation grid, and (2) integrals over curved surfaces, represented by NURBS patches. For integration over planar domains A that are parallel to one of the coordinate planes, moment fitting may be used. In moment fitting, given a set of predefined quadrature points, a system of equations is solved to compute corresponding quadrature weights such that a polynomial basis {p₁, . . . . , pₘ}, spanned by a set of m functions, is integrated exactly. However, due to the non-standard domain under consideration, basis functions cannot be integrated analytically, and for this reason a nesting is necessary.

According to the present design analysis solution, area integrals are transformed such that the bounding boxes of the transformed domains coincide with the unit square [0,1]², enabling the use of a single system matrix for the construction of all area and surface integrals. This confers far reaching advantages: Whenever shape parameters are changed, rules have to be updated. However, if the system matrix does not depend on the parameters, the system can be prefactorized and rules updated more efficiently. In addition, we can avoid having to take derivatives of the inverse of a matrix, leading to a significant performance increase for evaluations of shape derivatives.

More formally, to integrate over an area A that lies in the XY-plane, first an axis-aligned bounding box [a,b]×[c,d] is computed, then a mapping is defined between isoparametric variables ξ and η and the two spatial coordinates:

$$( \begin{matrix}X ( ξ ) \\ Y ( η )\end{matrix} ) = ( \begin{matrix}b - a & \\ & d - c\end{matrix} ) ( \begin{matrix}ξ \\ η\end{matrix} ) + ( \begin{matrix}a \\ c\end{matrix} ) \qquad ( Equation 11 )$$

Because of the linearity of the mapping, its Jacobian is constant and the transformed integral reads:

$${\int }_{\overline{A}} g ( X ( ξ ) , Y ( η ) , Z ) det ( \frac{\partial ( X , Y )}{\partial ( ξ , η )} ) d \overline{A} \qquad ( Equation 12 )$$

where Ā is the non-uniformly scaled domain, and the determinant of the Jacobian is set to the constant (b−a)(d−c).

Moment Fitting: To compute the quadrature weights, we form the system:

$$\underbrace{( \begin{matrix}{p}_{1} ( {ξ}_{1} , {η}_{1} ) & ⋯ & {p}_{1} ( {ξ}_{n} , {η}_{n} ) \\ ⋮ & ⋱ & ⋮ \\ {p}_{m} ( {ξ}_{1} , {η}_{1} ) & ⋯ & {p}_{m} ( {ξ}_{n} , {η}_{n} )\end{matrix} )}_{A} \underbrace{( \begin{matrix}{\overline{w}}_{1} \\ ⋮ \\ {\overline{w}}_{n}\end{matrix} )}_{w} = \underbrace{( \begin{matrix}{\int }_{\overline{A}} {p}_{1} ( ξ , η ) d \overline{A} \\ ⋮ \\ {\int }_{\overline{A}} {p}_{m} ( ξ , η ) d \overline{A}\end{matrix} )}_{b}$$

with constant matrix A, evaluating the basis functions at Gauss-Quadrature points. In order for moment fitting to be successful, there needs to be at least n≥m quadrature points, (ξⱼ, ηⱼ), forming an underdetermined system. To solve the system, we factorize the pseudo-inverse in the minimal-norm solution:

w=A^{T}(AA^{T})⁻¹b (Equation 13)

While matrix A is independent of the integration domain, the right side of Equation 13 is not. To evaluate b, we make use of the divergence theorem:

∫f_{Ā}pᵢ(ξ,η)dĀ=∫_{∂Ā}n(ξ,η)·Pᵢ(ξ,η)ds̅ (Equation 14)

Where n is the outward-facing normal at and:

$${P}_{i} ( ξ , η ) = \frac{1}{2} ( \begin{matrix}\int {p}_{i} ( ξ , η ) d ξ \\ \int {p}_{i} ( ξ , η ) d η\end{matrix} ) \qquad ( Equation 15 )$$

the antiderivative chosen such that ∇·Pᵢ=pᵢ. It is noted that the boundary of the domain ∂Ā consists of straight edge segments E and planar curves C analogous to those features shown in FIG. 5B, and the integration rules described above are used to integrate along them.

After construction, the weights and quadrature points may be transformed back to the original domain:

wⱼ=(b−a)(d−c)w̅ⱼ and Xⱼ=[X(ξⱼ),Y(ηⱼ),Z]^{T} (Equation 16)

For accurate integration over surfaces, we may make use of the parametric form of NURBS patches, expressing them as area integrals in parameter space:

∫_{S}g(X)dS=∫_{A}g(\hat{σ}(u,v))∥\hat{σ}ᵤ(u,v)×\hat{σ}ᵥ(u,v)∥dA (Equation 17)

Thus, integration weights are computed in uv-space, then transformed to physical coordinates by multiplication with the area factor ∥\hat{σ}ᵤ×\hat{σ}ᵥ∥.

Integration over volumes can be performed in a manner analogous to that for area integration described above. For example, we may compute a bounding box [a, b]×[c, d]×[e, f], and define a mapping to the unit cube. To evaluate the integrals of basis functions over the transformed domains, we use the area and surface rules developed above, establishing a second and final layer of nesting.

An important detail is that the non-uniform scaling S=diag(b−a, d−c, f−e) must be taken into account when we transform integrals over curved domains. We use the rule for linear transformations of cross products to account for this scaling in our surface integrals:

∫_{A}g(X)∥S\hat{σ}ᵤ×S\hat{σ}ᵥ∥dA=∫_{A}g(X)det(S)∥S^{-T}\hat{σ}ᵤ×\hat{σ}ᵥ∥dA (Equation 18)

The choices of bases for the construction of curve, area, and volume rules are not independent for two reasons: first, the curve or area rules are used to evaluate the flux of polynomials Pᵢ in the construction of the area and volume rules. Second, surface rules are used to evaluate polynomials in spatial coordinates arising from the finite element method, and therefore integrals over g∘\hat{σ} with polynomial g need to be approximated sufficiently well. These observations inform the choice of basis {ξⁱη^{j}ζ^{k}:i+j+k≤4} for the volume rules, and the compatible basis {ξⁱη^{j}:0≤i,j≤4} for the area rules. For surface rules, we may use the maximal degree of 5 instead of 4 to account for the nonlinearity of the area factor.

In use cases in which simulation of input model 140/240/440 is the goal of design analysis, the method outlined by flowchart 370 may conclude with action 375. However, where optimization of design parameters is the goal, flowchart 370 may conclude with optimizing the design parameter(s) identified in action 372 using the differentiable mathematical representation of input model 140/240/440 provided by the simulation generated in action 375 (action 376).

In some implementations, optimizing the design parameter(s) identified in action 372 improves the strength-to-weight ratio of mechanical object 242. Alternatively, or in addition, optimizing the design parameter(s) identified in action 372 may improve the mass distribution of mechanical object 242. As yet another alternative, or again additionally, optimizing the design parameter(s) identified in action 372 may result in an improved rest shape of mechanical object 242. Optimization of the design parameter(s) identified in action 372 using the differentiable mathematical representation of input model 140/240/440 included in the simulation generated in action 375 may be performed by design analysis software code 110/410, executed by hardware processor 104, and using optimization module 418.

In one implementation, for example, action 376 includes solving the following first-optimality constrained problem:

$${min}_{p} f ( {p}_{⊥} ( p ) , q ( {p}_{⊥} ) , x ( {p}_{⊥} ) ) s . t . [ \begin{matrix}{ℒ}_{p ⊥} \\ {ℒ}_{q} \\ {ℒ}_{λ}\end{matrix} ] = 0 and {E}_{x} = 0 \qquad ( Equation 19 )$$

It is noted that, compared to the formulation outlined above by reference to optimization stage 258, in FIG. 2, the direct dependence of the objective on the parameters is replaced with an implicit dependence p_{⊥}(p). Posing a design optimization in this particular way is advantageous because, during numerical optimization, the parameters p can take on values that do not fulfill our parameterization constraints, for example during line search along a descent direction. The combination of a continuous “projection” p_{⊥}(p), formulated with a first-order optimality constraint on a parameterization Lagrangian, and the use of only valid sets of parameters in objective evaluations, enables the use of a standard quasi-Newton for optimization where first-order optimality constraints are implicitly enforced.

In objective and objective gradient evaluations for a particular p, we first solve the Lagrangian to first-order optimality. We then use the resulting set of control points q(p_{⊥}) in the minimization of the potential energy E to equilibrium,

$$\frac{\partial E}{\partial x} ( q ( p ) , x ( p ) ) = 0.$$

To compute shape derivatives of our objective with respect to shape parameters

dₚf=fₚ_{_{⊥}}dₚp_{⊥}+f_{q}dₚq+fₓdₚx, (Equation 20)

we apply the implicit function theorem to our parameterization

$$[ \begin{matrix}{ℒ}_{{p}_{⊥} , {p}_{⊥}} & {ℒ}_{{p}_{⊥} , q} & {ℒ}_{{p}_{⊥} , λ} \\ {ℒ}_{q , {p}_{⊥}} & {ℒ}_{q , q} & {ℒ}_{q , λ} \\ {ℒ}_{λ , {p}_{⊥}} & {ℒ}_{λ , q} & \end{matrix} ] [ \begin{matrix}{d}_{p} {p}_{⊥} \\ {d}_{p} q \\ {d}_{p} λ\end{matrix} ] = - [ \begin{matrix}{ℒ}_{{p}_{⊥} , {p}_{⊥}} \\ {ℒ}_{q , p} \\ {ℒ}_{λ , p}\end{matrix} ] \qquad ( Equation 21 )$$

and quasi-static equilibrium E_{x,x}dₚx=−E_{x,q}dₚq, where the notation (*)ₚ is used for partial derivatives, and the notation dₚ(*) is used for total derivatives. For efficiency, the adjoint method may be used.

In implementations in which adjustments are made to the shape parameters, the volume V changes, and consequently the domains of the hierarchical rules being employed. While these changes are restricted to elements that were or are newly cut by the boundary, the cost of taking derivatives of rules can be considerable and requires a significant amount of bookkeeping. To reduce the computational complexity and simplify the implementation of shape derivatives, we describe how we can avoid some of the terms in our volume, area, and surface rules. It is noted that rule construction only depends on the control points of the boundary representation. As a result other dependencies can safely be ignored.

Area, Surface, and Volume Rules: To keep the matrix A in the moment fitting equation (i.e., Equation 13 above) constant, we seek to transform the non-standard domains. However, on the right-hand side of Equation 13, b depends on the shape of the non-standard domain, hence the quadrature points and weights, in general, depend on the shape parameters

$$\frac{d}{dp} {\int }_{D ( q )} g ( X ) dD = {Σ}_{j} ( \frac{{dw}_{j}}{dp} g ( {X}_{j} ) + {w}_{j} \frac{\partial g ( X )}{\partial X} \frac{{dX}_{j}}{dp} ) \qquad ( Equation 22 )$$

With respect to increasing the efficiency of rule derivatives, it is noted that, if the transformations for volume, area, and surface integrals are kept fixed after initial rule construction, the quadrature points no longer depend on the shape parameters for volume, area, and surface rules

$$\frac{d}{dp} {\int }_{D ( q )} g ( X ) dD = {Σ}_{j} \frac{{dw}_{j}}{dp} g ( {X}_{j} ) for D ∈ \{ A , S , V \} \qquad ( Equation 23 )$$

It is further noted that for edge and curve rules, the transformation from the general domain [a, b] to a standard domain [0, 1] is necessary. Otherwise, tabulated Gauss-Legendre rules cannot be applied. However, if we keep applying the initial transformation for area, surface, and volume rules, the weights, computed with the moment fitting equation, only depend on the right-hand side b of Equation 13 but not on a shape-dependent transformation. It is emphasized that these shape derivatives are exact if the function g is in the function space spanned by the bases used for rule construction.

Curve Rules: As noted above, it is in general not possible to extract an analytical parameterization for intersection curves that arise when several NURBS patches intersect within a grid element, or a NURBS intersects with one of the element planes. Consequently, we represent these planar or spatial curves with sample points, and distinguish between several example cases shown by FIG. 6 and discussed below.

During optimizations, changes are made to shape parameters, and implicitly also to control points. Changes to the control points, in turn, move the position of sample points on intersection curves. To treat NURBS patches and element planes the same, the element planes are parameterized, defining a mapping from parameter values u=[u, v]^{T} to plane points \hat{σ}(u) ∈ [symbol] ³. A sample point on two or more “surfaces” is then defined by a pair of uv-coordinates for each surface. In order to be able to compute shape derivatives, it is important to understand the relationship between these coordinates and the shape parameters.

To this end, it is best to look at a specific examples 680 and 688 in FIG. 6, where three “surfaces” intersect in a single point: if p is changed, the control points of the three patches and also the uv-coordinates in their respective parameter domain, change. What uniquely defines the uv-coordinates is the constraint that they all map to the same point in 3D, formalized with an equation \hat{σ}ᵢ(uᵢ(p), q(p))−\hat{σ}ⱼ(uⱼ(p), q(p)) for every pair (i, j) of “surfaces”. Collecting these equations in a system ϵ=0, and the uv-coordinates in a vector U, the implicit function theorem is used to compute analytical derivatives:

dₚU=−Σ_{U}⁻¹τ_{q}dₚq. (Equation 24)

However, this particular case shown by examples 680 and 688 is rare because real-world CAD models typically have filleted edges and corners with either all adjacent surfaces or subsets of them being tangent, as shown by example 682. In such cases, the Jacobian Σ_{U} becomes rank-deficient. Another case that leads to a rank-deficiency in Σ_{U} arises if sample points are placed on intersection curves that are defined by two “surfaces,” as shown by examples 684 and 686 in FIG. 6.

To be able to compute derivatives in these cases, sample points are first classified by analyzing the normals of adjacent surfaces. We then complement the equations in Σ=0 with planes that span the null space. For example, for a sample point on a sharp edge (examples 684 and 686), a plane may be defined whose normal is set to the cross product of the two surface normals. Because the components of derivatives that lie in this null space do not change the value of our integrals to first order, we can safely ignore them after computing the derivatives.

It is noted that, in some implementations, the simulation and optimization performed as respective actions 375 and 376 may repeat for two or more iterations. That is to say, optimization in action 376 may be followed by a second simulation in action 375, followed by another optimization, and so forth. Ultimately, action 376 results in optimized model 160/260/460 corresponding to input model 140/240/440 being output by design analysis software code 110/410. Once output by design analysis software code 110/410, optimized model 160/260/460 may be stored locally in system memory 106, or may be transmitted, via communication network 120 and network communication links 122, to user device 130.

In some implementations, optimized model 160/260/460 may be output for rendering on display 108, or may be output to user device 130 for rendering on display 138. As noted above. displays 108 and 138 may take the form of LCDs, LED displays, OLED displays, or any other suitable display screens that perform a physical transformation of signals to light. When output for rendering on display 108 of computing platform 102, rendering of optimized model 160/260/460 may be performed by design analysis software code 110/410, executed by hardware processor 104 of computing platform 102.

The optimization techniques described above enable a wide variety of applications, ranging from combined mass distribution and strength-to-weight ratio, or rest shape optimization, to various other inverse design problems that require an accurate integration of properties or discretized PDEs over a parameterized design domain enclosed by a boundary representation. One significant advantage of the present approach is that the simulation grid used in action 374 is independent of the parameterized boundary representation. As a result, in the context of strength-to-weight ratio or rest shape optimization, the same simulation grid can advantageously be used even for large changes of shape parameters.

Thus, the present application discloses systems and methods for performing automated analysis of mechanical designs, that overcome the drawbacks and deficiencies in the conventional art. From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. An automated mechanical design analysis system comprising:
a computing platform including a hardware processor and a system memory;
a software code stored in the system memory;
the hardware processor configured to execute the software code to:
receive an input model of a mechanical object;
identify at least one design parameter of the input model for automated analysis;
perform a parametric mapping of the input model based on the at least one design parameter to produce a parameterized model corresponding to the input model;
embed the parameterized model in a grid to produce a plurality of model-grid intersections defining a plurality of subvolumes of the parameterized model; and
generate a simulation of the input model based on the plurality of model-grid intersections and the plurality of subvolumes;
wherein the simulation of the input model comprises a differentiable mathematical representation of the input model.

2. The automated mechanical design analysis system of claim 1, wherein the input model is a boundary representation of the mechanical object.

3. The automated mechanical design analysis system of claim 2, wherein the input model comprises a plurality of Non-Uniform Rational Basis Spline (NURBS) patches forming a C⁰ surface.

4. The automated mechanical design analysis system of claim 2, wherein the input model comprises a Computer-Aided Design (CAD) model.

5. The automated mechanical design analysis system of claim 1, wherein a three-dimensional (3D) geometry of the grid remains constant.

6. The automated mechanical design analysis system of claim 5, wherein the grid is a regular hexahedral grid.

7. The automated mechanical design analysis system of claim 1, wherein hardware processor executes the software code to:
optimize, using the differentiable mathematical representation of the input model, the at least one design parameter for the input model; and
output an optimized model corresponding to the input model, the optimized model including the optimized at least one design parameter.

8. The automated mechanical design analysis system of claim 7, wherein optimizing the at least one design parameter improves a strength-to-weight ratio of the mechanical object.

9. The automated mechanical design analysis system of claim 7, wherein optimizing the at least one design parameter improves a mass distribution of the mechanical object.

10. The automated mechanical design analysis system of claim 7, wherein optimizing the at least one design parameter results in an improved rest shape of the mechanical object.

11. A method for use by an automated mechanical design analysis system including a computing platform having a hardware processor and a system memory storing a software code, the method comprising:
receiving, by the software code executed by the hardware processor, an input model of a mechanical object;
identifying, by the software code executed by the hardware processor, at least one design parameter of the input model for automated analysis;
performing a parametric mapping of the input model, by the software code executed by the hardware processor, based on the at least one design parameter to produce a parameterized model corresponding to the input model;
embedding the parameterized model in a grid, by the software code executed by the hardware processor, to produce a plurality of model-grid intersections defining a plurality of subvolumes of the parameterized model; and
generating a simulation of the input model, by the software code executed by the hardware processor, based on the plurality of model-grid intersections and the plurality of subvolumes;
wherein the simulation of the input model comprises a differentiable mathematical representation of the input model.

12. The method of claim 11, wherein the input model is a boundary representation of the mechanical object.

13. The method of claim 12, wherein the input model comprises a plurality of Non-Uniform Rational Basis Spline (NURBS) patches forming a C⁰ surface.

14. The method of claim 12, wherein the input model comprises a Computer-Aided Design (CAD) model.

15. The method of claim 11, wherein a three-dimensional (3D) geometry of the grid remains constant.

16. The method of claim 15, wherein the grid is a regular hexahedral grid.

17. The method of claim 11, further comprising:
optimizing, by the software code executed by the hardware processor and using the differentiable mathematical representation of the input model, the at least one design parameter for the input model; and
outputting, by the software code executed by the hardware processor, an optimized model corresponding to the input model, the optimized model including the optimized at least one design parameter.

18. The method of claim 17, wherein optimizing the at least one design parameter improves a strength-to-weight ratio of the mechanical object.

19. The method of claim 17, wherein optimizing the at least one design parameter improves a mass distribution of the mechanical object.

20. The method of claim 17, wherein optimizing the at least one design parameter results in an improved rest shape of the mechanical object.
